(19) United States
(12) Patent Application Publication
(10) Pub. No.: US 2025/0314767 A1
(43) Pub. Date: Oct. 9, 2025

(54) ULTRASONIC SENSOR AND SENSOR ATTACHMENT

(71) Applicant: DENSO CORPORATION, Kariya-city (JP)

(72) Inventors: Kenji FUKABORI, Kariya-city (JP); Kota TOYAMA, Kariya-city (JP)

(21) Appl. No.: 19/242,547

(22) Filed: Jun. 18, 2025

Related U.S. Application Data
(63) Continuation of application No. PCT/JP2023/041822, filed on Nov. 21, 2023.

(30) Foreign Application Priority Data
Dec. 22, 2022 (JP) 2022-205794

(51) Int. Cl. G01S 15/931

(52) U.S. Cl. CPC G01S 15/931; G01S 2015/938

(57) ABSTRACT

A sensor attachment (8) includes an attachment body (81) and resilient members (82). The attachment body is of a U-shape and includes a pair of extensions (814), a connecting portion (812), and an opening (811). The resilient members work to generate elastic force to hold the sensor attachment between a vehicle body component (V3) and a cylinder (72) of the housing member by inserting the extensions of the attachment body into attachment fit grooves (75b) formed in the housing member to slide in an attachment-inserting direction. The resilient members are configured to produce the elastic force which is lower at an initial stage of insertion of the extensions into the attachment fit grooves than at a subsequent stage of the insertion of the extensions following the initial stage.

### CROSS REFERENCE TO RELATED DOCUMENT

The present application claims the benefit of priority of Japanese Patent Application No. 2022-205794 filed on Dec. 22, 2022, the disclosure of which is incorporated in its entirety herein by reference.

### TECHNICAL FIELD

This disclosure generally relates to an ultrasonic sensor and a sensor attachment used to mount an ultrasonic sensor onto a body of a vehicle.

### BACKGROUND ART

First patent literature teaches an ultrasonic sensor mounted on a bumper of a vehicle and used as a corner sonar or a back sonar. The mounting of the bumper is achieved by inserting a body assembly of the ultrasonic sensor from outside the bumper into a hole formed in the bumper. The body assembly includes a main body of the ultrasonic sensor, a bezel, and an anti-vibration member. The bezel is made from synthetic resin in the form of a hollow cylinder. After the body assembly is inserted into the bumper, a retainer is secured to a back surface of the bumper. The retainer is made from synthetic resin and used to secure the main body of the ultrasonic sensor and the bezel to the bumper.

Specifically, the bezel is formed with a flange at one end. At the end of the bezel opposite to the flange, a slide surface is formed. This slide surface is configured to face the rear surface of the bumper and is symmetrically formed on both sides with respect to the hollow portion of the bezel. For example, the slide surface is formed by partially projecting the end of the bezel opposite to the flange. A retainer is fitted between this slide surface and the rear surface of the bumper in such a manner that it can slide.

The retainer includes a U-shaped portion and elastic portions. The U-shaped portion, which has a recessed center, is configured so that the bezel fits into the recessed center. The inner surfaces of the straight portions on both sides of the U-shape come into contact with the outer wall surface of the bezel, and the surface of the U-shaped portion opposite to the flange comes into contact with the sliding surface. Additionally, the surface of the U-shaped portion facing toward the flange is provided with each of the elastic portions. Each of the elastic portions is provided on a respective one of the straight portions on both sides of the U-shaped section. Each elastic portion is composed of two arch-shaped members, with one end serving as a fixed end supported by the U-shaped portion and the other end serving as a free end. In the state before the retainer is inserted between the sliding surface and the rear surface of the bumper, the height of each elastic portion is greater in size than the gap between the sliding surface and the rear surface of the bumper.

Using the above-described retainer, the sensor body and the bezel are inserted into a hole in the bumper, after which the retainer is slid into place between the sliding surface and the rear surface of the bumper. This secures the sensor body and the bezel firmly to the bumper. Specifically, when the retainer is inserted between the sliding surface and the rear surface of the bumper, a bulging portion located between the free end and the fixed end of the elastic portion comes into contact with the rear surface of the bumper, causing the elastic portions to deform elastically. As a result, the U-shaped portion and the elastic portions press against the sliding surface and the rear surface of the bumper by means of elastic force, thereby firmly retaining the sensor body and the bezel on the bumper.

### PRIOR ART DOCUMENT

### Patent Literature

FIRST PATENT LITERATURE: Japanese Patent First Publication No. 2018-146564

### SUMMARY OF THE INVENTION

In the configuration described in the first patent literature as mentioned above, it is necessary to apply a load to the elastic portions of the retainer in order to elastically deform the elastic portions when fitting the retainer on the bumper by sliding it. However, at the initial stage of fitting the retainer, the orientation of the retainer with respect to the sensor body or the bezel is not yet stabilized, and thus the direction of the load becomes unstable. Therefore, the configuration described in the first patent literature still has room for improvement in terms of workability when attaching the ultrasonic sensor to the bumper. The present disclosure has been made in view of such circumstances. That is, the present disclosure provides a technique for improving the workability, for example, when attaching an ultrasonic sensor to the bumper of a vehicle.

According to one aspect of this disclosure, there is provided sensor attachment for use in attaching an ultrasonic sensor to a plate-like vehicle body component. The ultrasonic sensor includes a hollow cylindrical housing member which has a cylinder and a flange functioning as a stopper. The cylinder is configured to be inserted into a through-hole formed in the vehicle body component. The cylinder has a first end and a second end opposed to the first end in an axial direction parallel to a center axis line thereof. The flange is formed on the first end and shaped to protrude away from the center axis line in a radial direction of the cylinder. The cylinder has a pair of attachment fit grooves formed in an outer periphery thereof. The attachment fit grooves open in the radial direction of the cylinder and extending in an attachment-inserting direction crossing the radial direction of the cylinder. The attachment fit grooves extend parallel to each other on both sides of the center axis line. The sensor attachment comprises: (a) an attachment body which is of a U-shape and includes a pair of extensions, a connecting portion, and an opening, the extensions extending parallel to each other in the attachment-inserting direction and each having a top end and a base end opposed to the top end in the attachment-inserting direction, the connecting portion extending to connect the base ends of the extensions together, the opening being shaped to open at the top ends of the extensions; and (b) resilient members which protrude from the attachment body in the axial direction and are shaped to be elastically deformable in the axial direction to generate elastic force in an elastically urging direction oriented toward the vehicle body component in a condition where the cylinder is inserted into the through-hole, and the attachment body is fit in the attachment fit grooves. The resilient members work to generate the elastic force to hold the sensor attachment between the vehicle body component and the cylinder by inserting the extensions of the attachment body into the attachment fit grooves to slide in the attachment-inserting direction and to have the cylinder disposed within the opening in a condition where the cylinder is inserted into the through-hole. The attachment body has housing contact surfaces which face in the axial direction and are configured to make contacts with the attachment fit grooves in the axial direction. Each of the housing contact surfaces includes an initially-inserted surface, a flat surface portion, and a slant surface portion. The initially-inserted surface is located on the top end of a corresponding one of the extensions. The flat surface portion is located closer to the base end of a corresponding one of the extensions than the initially-inserted surface is. The slant surface portion is located between the initially-inserted surface and the flat surface portion. The initially-inserted surface and the flat surface portion are aligned with each other in the attachment-inserting direction. The initially-inserted surface is offset from the flat surface portion in the elastically urging direction. The slant surface portion extends from the flat surface portion to the initially-inserted surface to slant in the elastically urging direction.

According to another aspect of this disclosure, there is provided an ultrasonic sensor which is configured to be attached to a plate-like vehicle body component. The ultrasonic sensor comprises a hollow cylindrical housing member and a sensor attachment. The housing member has a cylinder and a flange functioning as a stopper. The cylinder is configured to be inserted into a through-hole formed in the vehicle body component. The cylinder has a first end and a second end opposed to the first end in an axial direction parallel to a center axis line thereof. The flange is formed on the first end of the cylinder and shaped to protrude away from the center axis line in a radial direction of the cylinder. The sensor attachment is configured to be fit on the housing member to retain the housing member on the vehicle body component. The cylinder has a pair of attachment fit grooves formed in an outer periphery thereof. The attachment fit grooves open in the radial direction of the cylinder and extending in an attachment-inserting direction crossing the radial direction of the cylinder. The attachment fit grooves extend parallel to each other on both sides of the center axis line. The sensor attachment comprises an attachment body and resilient members. The attachment body is of a U-shape and includes a pair of extensions, a connecting portion, and an opening. The extensions extend parallel to each other in the attachment-inserting direction and each have a top end and a base end opposed to the top end in the attachment-inserting direction. The connecting portion extend to connect the base ends of the extensions together. The opening is shaped to open at the top ends of the extensions. The resilient members protrude from the attachment body in the axial direction and are shaped to be elastically deformable in the axial direction to generate elastic force in an elastically urging direction oriented toward the vehicle body component in a condition where the cylinder is inserted into the through-hole, and the attachment body is fit in the attachment fit grooves. The resilient members work to generate the elastic force to hold the sensor attachment between the vehicle body component and the cylinder by inserting the extensions of the attachment body into the attachment fit grooves to slide in the attachment-inserting direction and to have the cylinder disposed within the opening in a condition where the cylinder is inserted into the through-hole. The attachment body has housing contact surfaces which face in the axial direction and are configured to make contacts with the attachment fit grooves in the axial direction. Each of the housing contact surfaces includes an initially-inserted surface, a flat surface portion, and a slant surface portion. The initially-inserted surface is located on the top end of a corresponding one of the extensions. The flat surface portion is located closer to the base end of a corresponding one of the extensions than the initially-inserted surface is. The slant surface portion is located between the initially-inserted surface and the flat surface portion. The initially-inserted surface and the flat surface portion are aligned with each other in the attachment-inserting direction. The initially-inserted surface is offset from the flat surface portion in the elastically urging direction. The slant surface portion extends from the flat surface portion to the initially-inserted surface to slant in the elastically urging direction.

In this disclosure, reference numbers or symbols in brackets only represent correspondence relations to elements discussed in an embodiment or modifications, as described below. This disclosure is, therefore, not limited to the elements denoted by the reference numbers or symbols.

### BRIEF DESCRIPTION OF THE DRAWINGS

FIG. 1 is a perspective view illustrating the exterior of a vehicle equipped with ultrasonic sensors according to an embodiment.

FIG. 2 is a plan view illustrating the ultrasonic sensor shown in FIG. 1 in a vehicle-mounted state.

FIG. 3 is a plan view illustrating a schematic configuration of a sensor body shown in FIG. 2.

FIG. 4 is a partial cross-sectional view of the sensor body shown in FIG. 3.

FIG. 5A is an enlarged plan view illustrating an anti-vibration spacer shown in FIG. 2.

FIG. 5B is a front view illustrating the anti-vibration spacer shown in FIG. 5A.

FIG. 6 is a plan view illustrating a schematic configuration of a secondary assembly in which the sensor body, the anti-vibration spacer, and the bezel shown in FIG. 2 are installed.

FIG. 7 is an enlarged plan view illustrating the bezel shown in FIG. 6.

FIG. 8A is a rear view which illustrates a retainer shown in FIG. 2.

FIG. 8B is a side view illustrating the retainer shown in FIG. 2.

FIG. 8C is a side cross-sectional view illustrating the retainer shown in FIG. 2.

FIG. 8D is a perspective view illustrating the retainer shown in FIG. 2.

FIG. 9 is a side view illustrating a state in which the ultrasonic sensor is mounted to a bumper using the retainer illustrated in FIGS. 8A to 8D.

FIG. 10 is a side view illustrating a comparative example, in which an ultrasonic sensor is mounted to a bumper using a retainer.

### MODE FOR CARRYING OUT THE INVENTION

Embodiments in this disclosure will be described below with reference to the drawings. Possible modifications of each embodiment will be discussed together following explanation of the embodiments in order not to disturb understanding of each embodiment.

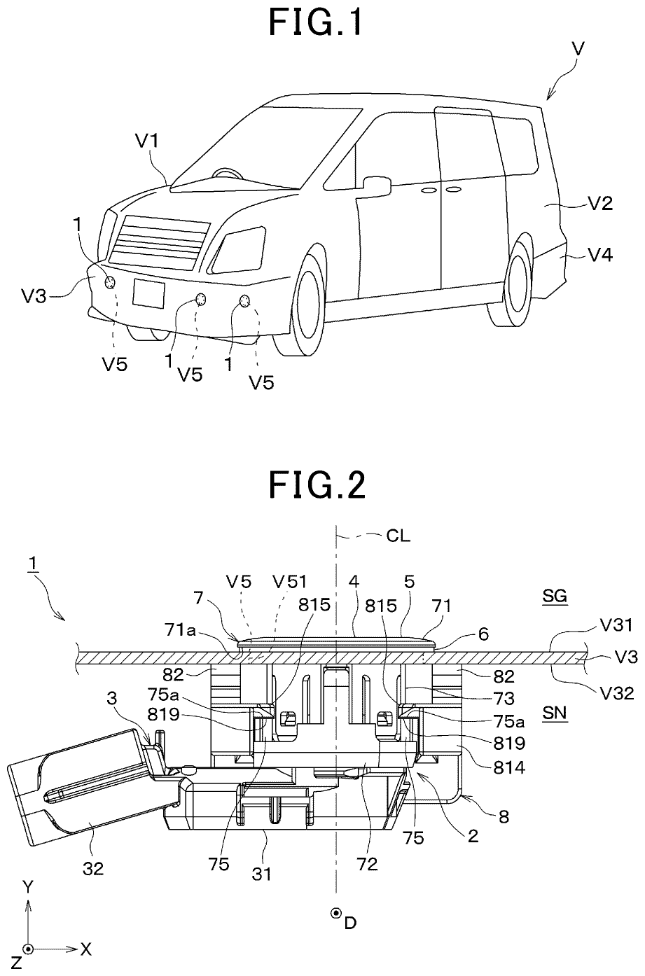

Referring to FIG. 1, the ultrasonic sensors 1 in this embodiment are configured as vehicle-mounted clearance sonars attached to the vehicle V. Each of the ultrasonic sensors 1 mounted in the vehicle V works to detect an object(s) around the vehicle V.

The vehicle V is a four-wheeled automotive vehicle and equipped with the box-shaped vehicle body V1, the body panel V2 that is a plate-like body member, i.e., an exterior body panel, the front bumper V3, and the rear bumper V4. The front bumper V3 is attached to a front end of the vehicle body V1. The rear bumper V4 is attached to a rear end of the vehicle body V1. The front bumper V3 and the rear bumper V4 are made of metallic plates.

Some of the ultrasonic sensors 1 are configured to be secured to the front bumper V3 to detect an object existing in front of or on a front lateral side of the vehicle V. The other ultrasonic sensors 1 are also configured to be secured to the rear bumper V4 to detect an object existing in the back of or a rear lateral side of the vehicle V. In the following discussion, the state where each of the ultrasonic sensors 1 is attached to the front bumper V3 or the rear bumper V4 secured to the vehicle body V1 will be referred to as an on-vehicle state or a vehicle-mounted state.

Specifically, in the vehicle-mounted state, a plurality of (e.g., four) ultrasonic sensors 1 are mounted in the front bumper V3. The ultrasonic sensors 1 in the front bumper V3 are located away from each other in the width-wise direction of the vehicle V. Similarly, a plurality of (e.g., four) ultrasonic sensors 1 are mounted in the rear bumper V4. Each of the front bumper V3 and the rear bumper V4 has the mounting holes V5 formed therein in the shape of through-holes in which the ultrasonic sensors 1 are fit. The mounting or demounting of the ultrasonic sensors 1 in or from the front bumper V3 is usually achieved after the front bumper V3 is removed from the vehicle body V1. The vehicle-mounted state, as referred to in this disclosure, also includes a state where the ultrasonic sensors 1 are merely installed in the front bumper V3 without the front bumper V3 being attached to the vehicle body V1. The same applies to the mounting or demounting of the ultrasonic sensors 1 in or from the rear bumper V4.

### Ultrasonic Sensor

FIG. 2 illustrates one of the ultrasonic sensors 1 attached to the front bumper V3 in the vehicle-mounted state. The overall structure of each of the ultrasonic sensors 1 in this embodiment will be described below with reference to FIG. 2. The ultrasonic sensors 1 may be attached to the rear bumper V4 in the same way as to the front bumper V3. For the sake of simplicity, FIG. 2 illustrates the ultrasonic sensor 1 to the front bumper V3, however, the same applies to the rear bumper V4. The following discussion with reference to FIG. 2 and the subsequent drawings will refer only to the front bumper V3 for the sake of convenience. In the following discussion, the front bumper V3 or the rear bumper V4 will generally be referred to as a bumper. For the sake of convenience of explanation, a right-handed Cartesian coordinate (X, Y, Z) system is defined based on a direction of gravity's pull in the vehicle-mounted state. In the illustrated right-handed coordinate system, an upward direction (i.e., a vertical upward direction) will be referred to as a positive Z-axis direction. The vertical upward direction, as referred to herein, is a direction parallel to and opposite to a direction of the force of gravity when the vehicle V is placed in a drivable condition on a horizontal plane. The upward direction, as referred to herein, coincides with the vertical upward direction or a direction oriented at a small acute angle α (e.g., 10° or less) to the vertical upward direction. The positive Z-axis direction, therefore, becomes identical with the upward vertical direction or a direction traversing the vertical upward direction depending upon the configuration of the front bumper V. Similarly, the positive Y-axis direction becomes identical with the horizontal direction or a direction traversing the horizontal direction.

The bumper has the outer bumper surface V31 and the inner bumper surface V32. The outer bumper surface V31 is an outside surface of the bumper which faces or is exposed to the bumper-outside space SG existing outside the vehicle V in the vehicle-mounted state. The inner bumper surface V32 is an inside surface of the outer bumper surface V31 which faces or is exposed to the bumper-inside space SN existing inside the vehicle V in the vehicle-mounted state. Each of the mounting holes V5 opens at the outer bumper surface V31 and the inner bumper surface V32, in other words, extends through a thickness of the front bumper V3. Each of the mounting holes V5 is in the form of a circular hole defining a circular cylindrical space in the front bumper V3. Each of the mounting holes V5, therefore, has the cylindrical inner surface V51.

Each of the ultrasonic sensors 1 is configured to generate or sense ultrasound energy. Specifically, each of the ultrasonic sensors 1 is designed to emit a detecting wave in the form of ultrasound into the bumper-outside space SG along the center axis line CL. Each of the ultrasonic sensors 1 also works to receive a wave including a return (which will also be referred to as a reflected wave) of the detecting wave from an object existing in the bumper-outside space SG and analyze the received wave to output a sensing signal created using results of the analysis of the received signal. In the illustrated right-handed coordinate (X, Y, Z) system illustrated in FIG. 2, a direction in which the detecting wave is outputted and which extends parallel to the center axis line CL that coincides with a directivity axis (i.e., an axis of maximum radiation intensity) of each of the ultrasonic sensors 1 will also be referred to as a positive Y-axis direction. The directivity axis, as referred to herein, is defined by an imaginary straight line extending in a direction in which ultrasound, as emitted from the ultrasonic sensor 1, travels. The directivity axis serves as a base for defining a directivity angle. The directivity axis is also referred to as a center directivity axis or a sensing axis. A positive Y-axis direction oriented parallel to the directivity axis will also be referred to as an axial direction. In the following discussion, assuming that a member shaped to extend in the axial direction has ends opposed to each other in the axial direction, one of the ends of the member which faces in the positive Y-axis direction will also be referred to as a front end or a front end portion facing in the axial direction, while the other end of the member which faces in a negative Y-axis direction will also be referred to as a base end or a base end portion facing in the axial direction. A dimension of a member or a part of the member, as discussed below, which is measured in the axial direction will also be referred to as an axial direction dimension.

In the following discussion, a direction perpendicular to the axial direction will also be referred to as an in-plane direction which extends parallel to an X-Z plane. The shape of a member, as viewed on a plane extending orthogonal to the center axis line CL, in other words, as projected onto the X-Z plane, will also be referred to as an in-plane shape. The in-plane direction includes a radial direction and a circumferential direction. The radial direction is defined as a direction extending radially from the center axis line CL. In other words, the radial direction is oriented at right angles to the center axis line CL and extends away from the center axis line CL. Specifically, given a point of intersection of the center axis line CL with an imaginary plane, as defined perpendicular to the center axis line CL, and an initial point that is such a point of intersection, the radial direction coincides with a direction along a half-line defined to extend from the initial point on the imaginary plane. In other words, given an imaginary circle is defined on the imaginary plane, and the center of the imaginary circle lies at the point of intersection between the imaginary plane and the center axis line CL, the radial direction is a direction along the radius of the imaginary circle. The circumferential direction is defined along a circumference of the above imaginary circle extending around the center axis line CL.

Each of the ultrasonic sensors 1 is mounted in the vehicle V to have the center axis line CL extending substantially parallel to a thickness-wise direction of a portion of the front bumper V3 which is near a mounting location where a corresponding one of the ultrasonic sensors 1 is attached to the front bumper V3. The mounting location, as referred to herein, is where each of the ultrasonic sensors 1 is attached to the front bumper V3, in other words, the center of each of the mounting holes V5. The center of each of the mounting holes V5, as referred to herein, is the center of a circle defined by a line of intersection between the edge of the cylindrical inner surface V51 of the mounting hole V5 and the outer bumper surface V31 or the inner bumper surface V32. In other words, the center of each of the mounting holes V5 may be presumed to the position of the center axis line CL on an X-Z coordinate plane in the vehicle-mounted state or the bumper-mounted state.

Each of the ultrasonic sensors 1 is equipped with the sensor body 2. The sensor body 2 includes the sensor case 3, the ultrasonic microphone 4, and the cushion 5. The sensor body 2 is attached to the bumper using the anti-vibration spacer 6, the bezel 7, and the retainer 8. In other words, each of the ultrasonic sensors 1 placed in the vehicle-mounted state is made up of the sensor case 3, the ultrasonic microphone 4, the cushion 5, the anti-vibration spacer 6, the bezel 7, and the retainer 8. The parts of each of the ultrasonic sensors 1 will be described below in detail.

### Sensor Case

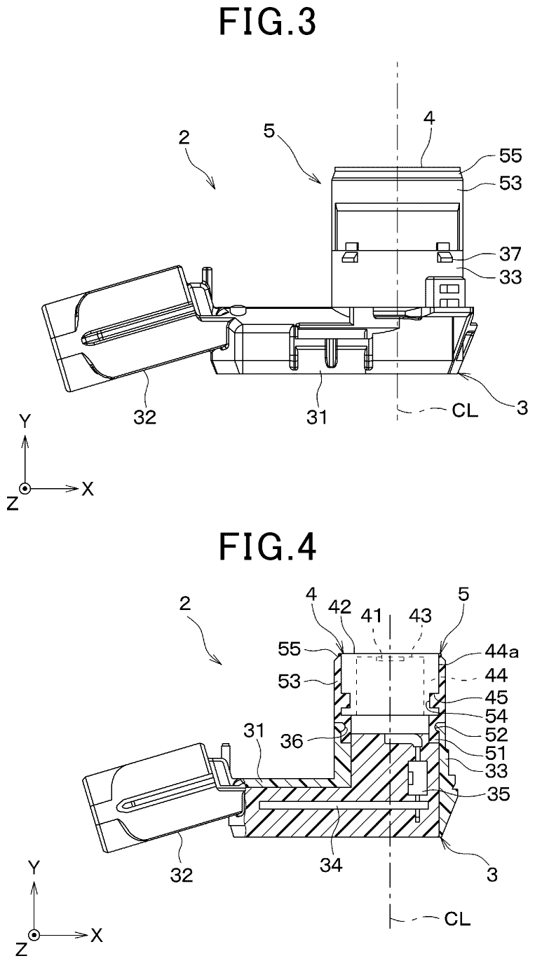

The sensor case 3 serving as a housing of the ultrasonic sensor 1, i.e., the sensor body 2 is made from a hard synthetic resin, such as polybutylene terephthalate, acrylonitrile-butadiene-styrene (ABS) resin, polypropylene, polycarbonate, or polystyrene. FIG. 3 illustrates the sensor body 2 after the retainer 8 is removed from the ultrasonic sensor 1 illustrated in FIG. 2, pulling a sub-assembly of the ultrasonic sensor 1 from which the retainer 8 is removed toward the bumper-outside space SG, and then dismounting the bezel 7 from the sub-assembly. The sub-assembly, as referred to herein, is an assembly of the sensor body 2, the anti-vibration spacer 6, and the bezel 7. The sensor body 2 is a primary assembly of the sensor case 3, the ultrasonic microphone 4, and the cushion 5. A state where the secondar assembly is completed will also be referred to below as an assembly state. The assembly state includes the bumper-mounted state and the vehicle-mounted state.

Referring to FIG. 3, the sensor case 3 includes the box 31, the connector 32, and the microphone support 33. The box 31, the connector 32, and the microphone support 33 are made in the form of a seamless one-piece member using mold injection techniques. The box 31 is of a flat-box shape and has a length extending in the X-axis direction and a thickness in the Y-axis direction in the bumper-mounted state. The box 31, as can be seen in FIG. 4, has the circuit board 34 disposed therein. The circuit board 34 is electrically connected to the ultrasonic microphone 4 using the connecting wires 35.

The box 31 has a length with a first end (i.e., a left end, as viewed in FIGS. 3 and 4) and a second end opposed to the first end. The connector 32 extends from the first end of the box 31 horizontally and obliquely backward in the vehicle-mounted state. In other words, the connector 32 extends away from the bumper in the bumper-mounted state. The connector 32 is designed in the form of a receptable connector which is joinable to or detachable from a plug connector, not shown, attached to an end of a wire harness used for electrical connection with an external device, such as an electronic control unit (ECU).

The microphone support 33 extends in the axial direction from the second end (i.e., a right end, as viewed in FIGS. 3 and 4) of the box 31. The microphone support 33 is of a hollow cylindrical shape surrounding the center axis line CL. In this embodiment, the microphone support 33 is shaped to have a center axis coinciding with the center axis line CL.

The microphone support 33 has a front end which faces in the axial direction and on which the cushion-fitting protrusion 36 and the bezel-fitting protrusions 37 are formed. The cushion-fitting protrusion 36 bulges toward the center axis line CL from a cylindrical inner wall surface of the microphone support 33 which surrounds the center axis line CL. The cushion-fitting protrusion 36 also extends on an entire circumference of the microphone support 33. The bezel-fitting protrusions 37 are in the form of small protrusions which radially and outwardly bulge from a cylindrical outer wall surface of the microphone support 33. The bezel-fitting protrusions 37 are arranged away from each other in the radial direction of the microphone support 33.

### Ultrasonic Microphone

Referring to FIG. 4, the ultrasonic microphone 4 is of a cylindrical outer shape extending in the axial direction thereof. Specifically, the ultrasonic microphone 4 is in the shape of a circular cylinder whose center axis coincides with the center axis line CL. The ultrasonic microphone 4 includes the ultrasonic device 41 and the microphone case 42. The ultrasonic device 41 is implemented by an electrical energy-to-mechanical energy transducer made of a thin-film piezoelectric device. The ultrasonic device 41 is disposed inside the microphone case 42.

The microphone case 42 serves as a housing for the ultrasonic microphone 4 and is made in the form of a bottomed hollow cylinder from a metallic material, such as aluminum. Specifically, the microphone case 42 includes the diaphragm 43 and the side plate 44. The diaphragm 43 is in the form of a thin plate having a thickness, as measured in the axial direction thereof. The diaphragm 43 is arranged to close a front end of the side plate 44 which faces in the axial direction. In the bumper-mounted state or the vehicle-mounted state, the diaphragm 43 is oriented to have a smooth outer surface exposed to the bumper-outside space SG. The diaphragm 43 has an inner surface which is opposed to the outer surface thereof and on which the ultrasonic device 41 is fixed.

The side plate 44 of the microphone case 42 is of a substantially hollow cylindrical shape and extends in the axial direction. The side plate 44 has the side surface 44a which defines an outer wall surface of the ultrasonic microphone 4. The side surface 44a is of a cylindrical shape and has a center axis coinciding with the center axis line CL. The side surface 44a of the side plate 44 has a pair of joint grooves 45 formed therein. Each of the joint grooves 45 is in the form of a square groove extending parallel to the Z-axis direction in the drawings. The joint grooves 45 are diametrically opposed to each other across the center axis line CL.

### Cushion

The cushion 5 is seamlessly made from an elastic synthetic resin, such as silicon rubber. The cushion 5 that is one of parts of the sensor body 2 is fit on the sensor body 2 (i.e., the primary assembly) along with the ultrasonic microphone 4. The cushion 5 is in the form of a hollow cylindrical shape surrounding the center axis line CL. Specifically, the cushion 5 in this embodiment is of a hollow cylindrical shape surrounding the center axis line CL and has an outer diameter substantially identical with that of the microphone support 33 and an inner diameter substantially identical with an outer diameter of the side plate 44. The cushion 5 is shaped to have a length greater than that of the ultrasonic microphone 4 in the axial direction.

The cushion 5 has the supported portion 51 that is a base end facing in the axial direction and is secured at the supported portion 51 to the microphone support 33. Specifically, the supported portion 51 has formed therein the joint groove 52 opening in the radial direction. The joint groove 52 is shaped to achieve a mechanical joint to the cushion-fitting protrusion 36 of the microphone support 33. The joint groove 52 extends in the circumferential direction. The cushion 5 has the microphone housing 53 formed in an end portion thereof which is located closer to the end of the cushion 5 than the supported portion 51 is. The microphone housing 53 is shaped to have substantially the whole of the ultrasonic microphone 4 stored therein in the axial direction. Specifically, the microphone housing 53 has a cylindrical inner space which is configured to conform with the outline of the ultrasonic microphone 4 and cover the side surface 44a of the ultrasonic microphone 4. The microphone housing 53 has a pair of fitting protrusions 54 formed thereon. The fitting protrusions 54 are diametrically opposed to each other across the center axis line CL. Each of the fitting protrusions 54 is in the form of a projection which has a rectangular cross section and bulges toward the center axis line CL. Each of the fitting protrusions 54 is shaped to be fit in one of the joint grooves 45 and extends in the Z-axis direction in the drawings. The microphone housing 53 of the cushion 5 has the top end portion (i.e., a head) 55 which faces in the axial direction and tapers to have an outer diameter decreasing toward the top end of the microphone housing 53.

As apparent from the above discussion, the cushion 5 which has the base end and the front end opposed to the base end in the axial direction is secured at the base end to the sensor case 3 and elastically retains the ultrasonic microphone 4 in the front end. Specifically, each of the ultrasonic sensors 1 has the ultrasonic microphone 4 elastically retained by the sensor case 3 through the cushion 5, thereby minimizing transmission of mechanical vibration between the sensor case 3 and the ultrasonic microphone 4. Each of the ultrasonic microphones 4 also has the cushion 5 located between the ultrasonic microphone 4 and the bezel 7 which surrounds the side surface 44a of the ultrasonic microphone 4 in the vehicle-mounted state. In other words, the cushion 5 is arranged between the ultrasonic microphone 4 and the bumper, thereby absorbing transmission of vibration between the ultrasonic microphone 4 and the bumper.

### Anti-Vibration Spacer

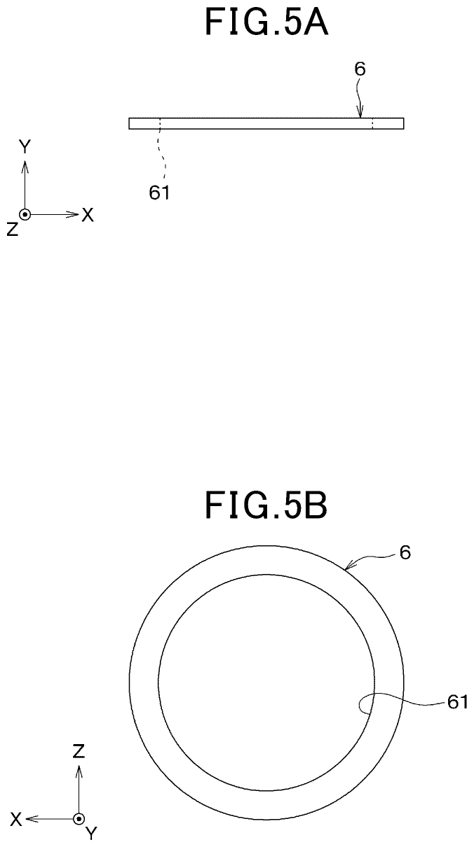

Referring to FIGS. 5A and 5B, the anti-vibration spacer 6 is in the shape of a thin ring and has a thickness as measured in the axial direction. The anti-vibration spacer 6 is made from an elastic synthetic resin, such as silicone rubber. Specifically, the anti-vibration spacer 6 is in the form of a disc plate and has the spacer through-hole 61 formed in the center of the disc plate. The anti-vibration spacer 6 is, as clearly illustrated in FIG. 2, arranged between the flange 71, as will be described later in detail, of the bezel 7 and the bumper to minimize the transmission of mechanical vibration between the bezel 7 and the bumper in the vehicle-mounted state. Specifically, the anti-vibration spacer 6 is firmly retained by the reverse surface 71a of the flange 71 which faces the bumper and the outer bumper surface V31 in the bumper-mounted state.

### Bezel

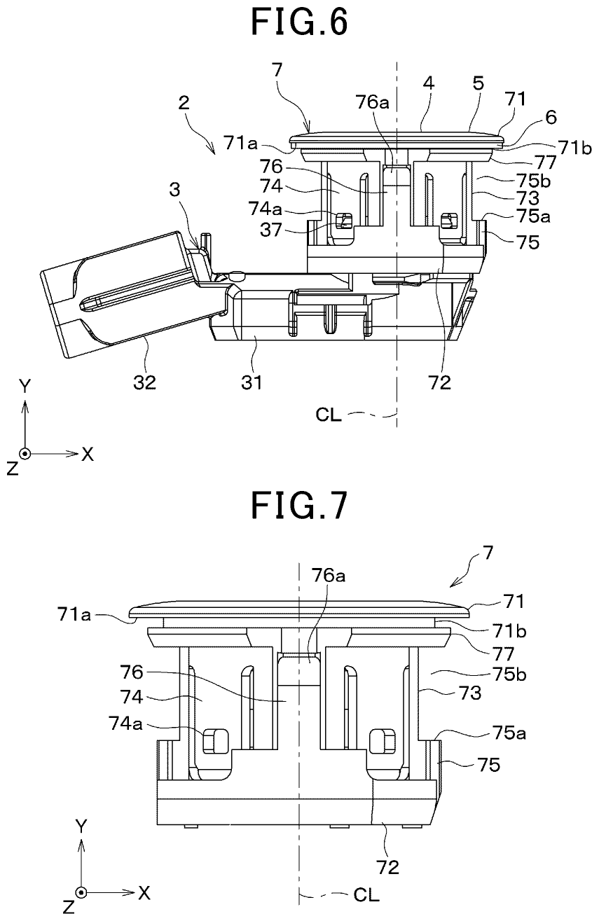

FIG. 6 illustrates the above-described sub-assembly (also called a secondary assembly). In the sub-assembly or the ultrasonic sensor 1 illustrated in FIG. 2, the bezel 7 defines a housing along with the sensor case 3. FIG. 7 is an enlarged view of the bezel 7 shown in FIG. 6. The bezel 7 is a member used to attach the ultrasonic sensor 1 to the plate-like bumper. The bezel 7 is of a hollow cylindrical shape and made from a hard synthetic resin. The structure of the bezel 7 which is designed as a housing member and oriented, as shown in FIGS. 2, 6, and 7, to have a longitudinal center line coinciding with the center axis line CL in use will be described below.

The bezel 7 has the top end (which will also be referred to below as a first end) and the base end (which will also be referred to below as a second end) opposed to the top end in the axial direction thereof. The top end of the bezel 7 forms the flange 71. The flange 71 is in the shape of a protrusion or overhang and functions as a stopper to hold the secondary assembly when inserted into the mounting holes V5 and secured to the bumper. Specifically, the flange 71 is in a ring shape and has a thickness as measured in the axial direction. The flange 71 is shaped to have an outer diameter larger than an inner diameter of the mounting hole V5. In the bumper-mounted state, the flange 71, as clearly illustrated in FIG. 2, faces a portion of the outer bumper surface V31 around the mounting hole V5 through the anti-vibration spacer 6. The flange 71 has the back surface 71a which is of a planner shape.

The bezel 7 has the spacer housing groove 71b which is formed in the front end portion thereof and located closer to the base end than the flange 71 is in the axial direction. The spacer housing groove 71b opens in the radial direction of the bezel 7 to define a housing in which the anti-vibration spacer 6 is fit and is arranged adjacent the flange 71. The spacer housing groove 71b has a width, in other words, an axial dimension, as measured in in the axial direction of the bezel 7, which is substantially identical with the thickness of the anti-vibration spacer 6. The spacer housing groove 71b also has a depth, in other words, a radial dimension which substantially corresponds to the diameter of the spacer though-hole 61 in the anti-vibration spacer 6. In other words, the bottom of the spacer housing groove 71b coincides with the outer periphery of the spacer through-hole 61. The spacer housing groove 71b extends an entire circumference of the bezel 7.

The spacer housing groove 71b is disposed between the flange 71 and the cylinder 72. Specifically, the flange 71 protrudes radially from the front end portion of the cylinder 72 extending in the axial direction of the bezel 7. The flange 71 and the cylinder 72 are formed integrally with each other and made from the same material without any seams. The cylinder 72 is configured to be inserted into the mounting hole V5 and surrounds the cushion 5 and the ultrasonic microphone 4 in the assembled state or the bumper-mounted state. The cylinder 72 has an outer diameter slightly smaller than an inner diameter of the mounting hole V5 and also has an inner diameter slightly greater than outer diameters of the microphone support 33 and the cushion 5.

The main body 73 including of an axial center portion of the cylinder 72 extends along the center axis line CL. The main body 73 has the sensor-fitting arms 74 each of which has a thickness as measured in the radial direction of the main body 73. Each of the sensor-fitting arms 74 extends in the form of a cantilever in a direction from the front end to the base end of the main body 73. Specifically, each of the sensor-fitting arms 74 is shaped to have a front end and a base end opposed to the front end in the axial direction of the main body 73 and configured to have a supported or fixed end defined by the front end and a free end defined by the base end. Each of the sensor-fitting arms 74 is elastically deformable to have the free end movable in the radial direction of the main body 73. Each of the sensor-fitting arms 74 has the snap-fit hole 74a formed in a portion thereof close to the free end. The snap-fit hole 74a extends through the thickness of the sensor-fitting arm 74. Each of the bezel-fitting protrusions 37 of the microphone support 33 is detachably fit in a corresponding one of the snap-fit holes 74a in the assembled state. The main body 73 has the same number of the sensor-fitting arms 74 as the bezel-fitting protrusions 37.

The base end protrusions 75 are integrally joined to the base end portion of the main body 73 and bulge in the radial direction of the main body 73. The main body 73 and the base end protrusions 75 are formed integrally with each other and made of the same material without any seams. The base end protrusions 75 have the retainer contact faces 75a defining front ends of the base end protrusions 75. Each of the retainer contact faces 75a is of a smooth planar shape having a normal line extending parallel to the center axis line CL.

The retainer contact faces 75a are shaped to define surfaces of the front ends of the base end protrusions 75 which face or are exposed to a pair of retainer fit grooves 75b in the axial direction of the bezel 7. The retainer fit grooves 75b are formed in the main body 73 and configured as attachment fit grooves. Specifically, the retainer fit grooves 75b are formed on an outer periphery of the cylinder 72 and open in the radial direction of the cylinder 72. Each of the retainer fit grooves 75b extends in a retainer-inserting direction (also called an attachment-inserting direction) that is a direction which traverses the center axis of the bezel 7, that is, in the Z-axis direction in the drawings. Specifically, each of the retainer fit grooves 75b is shaped to have a rectangular cross section to allow the retainer 8 to be inserted thereinto when the ultrasonic sensor 1 is attached to the bumper. The retainer fit grooves 75b extend parallel to each other on opposite sides the center axis line CL. In other words, the retainer fit grooves 75b extend symmetrically about the center axis line CL. Each of the base end protrusions 75 is shaped to firmly hold the retainer 8 between itself and the inner bumper surface V32 in the bumper-mounted state.

The cylinder 72 has the temporary assembling arms 76. Each of the temporary assembling arms 76 has a thickness in the radial direction of the cylinder 72 and is in the form of a cantilever. The temporary assembling arms 76 extend in the axial direction from the base end protrusions 75 toward the flange 71. In other words, each of the temporary assembling arms 76 has a based end defining a supported or fixed end and a front end defining a free end which is opposed to the fixed end in the axial direction and elastically movable in the radial direction of the cylinder 72. Each of the temporary assembling arms 76 has the temporary assembling protrusion 76a which is formed on the free end thereof and bulges in the radial direction of the cylinder 72. The temporary assembling protrusions 76a serve to hold the secondary assembly in a temporarily assembled state. The temporarily assembled state, as referred to in this disclosure, is a state where the secondary assembly is temporarily retained by the bumper in a temporarily assembled orientation, which is achieved by inserting the bezel 7 of the secondary assembly into the mounting hole V5. The temporarily assembled orientation is an orientation of the secondary assembly in which the anti-vibration spacer 6 directly contacts or lies close to the outer bumper surface V31, and the connector 32 extends in the negative X-direction shown in FIG. 2. The temporarily assembled state is a state where the retainer 8 is removed from the ultrasonic sensor 1 placed in the vehicle-mounted state or the bumper-mounted state.

The main body 73 has the front protrusion 77 which is formed on the front end portion thereof. The front protrusion 77 is joined integrally with the main body 73 and bulges in the radial direction of the main body 73. The front protrusion 77 defines a top end of the cylinder 72 which faces in the axial direction. The front protrusion 77 extends in the circumferential direction of the main body 73. The main body 73 and the front protrusion 77 are made from the same material in the form of a one-piece unit without any seams. The front protrusion 77 is disposed between the spacer housing groove 71b and the retainer fit grooves 75b in the axial direction of the bezel 7. In other words, the front protrusion 77 is arranged adjacent both to the spacer housing groove 71b and to the retainer fit grooves 75b in the axial direction. The spacer housing groove 71b is defined by an air gap between the flange 71 and the front protrusion 77. Each of the retainer fit grooves 75b is defined by an air gap between a corresponding one of the base end protrusions 75 and the front protrusion 77. In the bumper-mounted state, the front protrusion 77 is disposed in a corresponding one of the mounting holes V5 and faces the cylindrical inner surface V51.

### Retainer

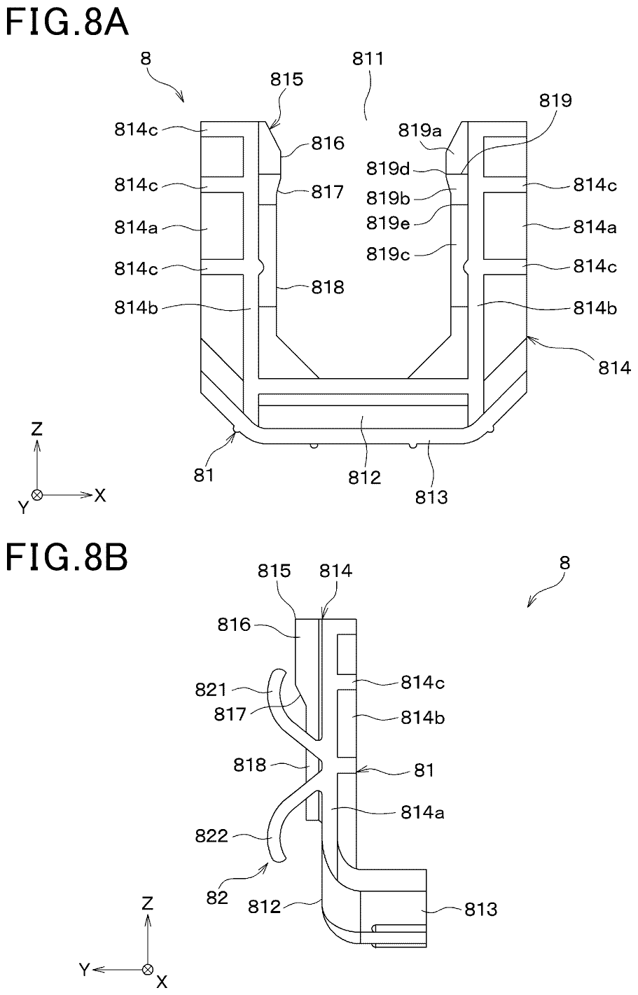

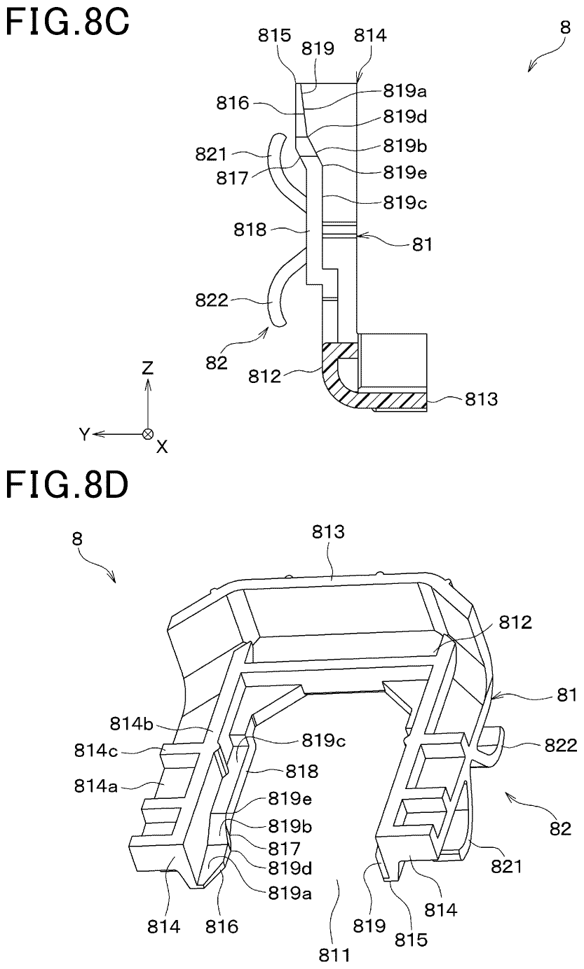

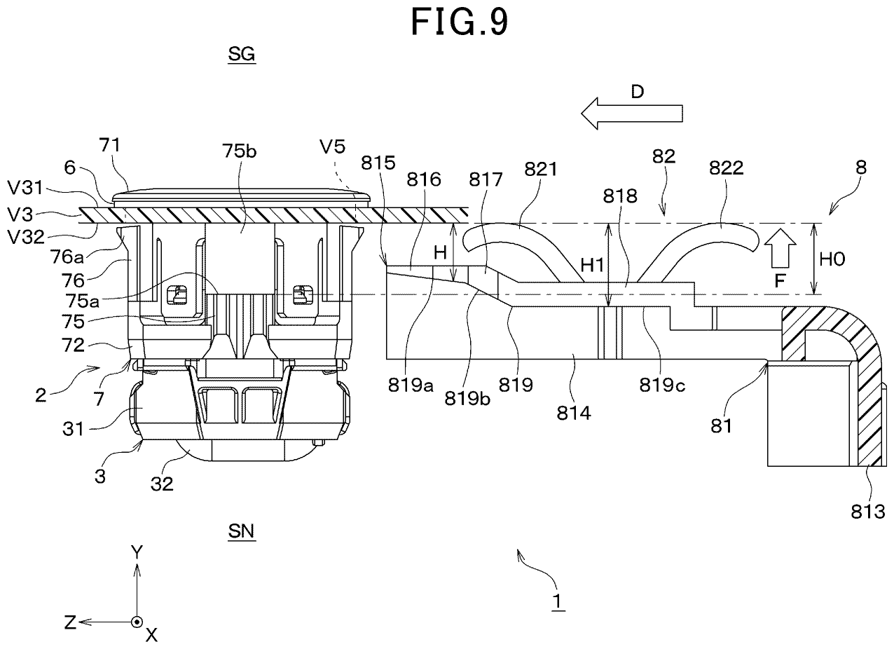

Referring back to FIG. 2, the retainer 8 that is used as a sensor attachment in this disclosure is a component for fastening the ultrasonic sensor 1 to the bumper that is a plate-like part of the vehicle V. The retainer 8 is formed by a one-piece member made from a hard synthetic resin. FIGS. 8A to 8D schematically illustrate the structure of the retainer 8. FIG. 9 demonstrates how to fit the retainer 8 on the secondary assembly placed in the temporarily assembled state. The structure of the retainer 8 will be described below in detail with reference to FIGS. 2, 8A to 8D, and 9. In FIGS. 2 and 9, an arrow D indicates a direction in which the retainer 8 is inserted into a clearance between the cylinder 72 and the bumper and will also be referred to below as a pressing direction.

The retainer 8 is attached to the secondary assembly which has been inserted into the mounting hole V5 and placed in the temporarily assembled state, thereby firmly securing the ultrasonic sensor 1 to the bumper. Specifically, retention of the retainer 8 between the cylinder 72 and the bumper in the vehicle-mounted state is achieved by inserting the retainer 8 into between each of the base end protrusions 75 of the cylinder 72 and the bumper with the cylinder 72 disposed in the mounting hole V5.

The retainer 8 includes the retainer body 81 and the resilient members 82. The retainer body 81 used as an attachment body in this disclosure, as illustrated in FIG. 8A, is of a U-shape and has the opening 811 facing in the Z-axis direction in the drawings. The retainer 8 also includes the connecting portion 812 located away from the opening 811. The connecting portion 812 extends in a width direction of the retainer body 81, i.e., the X-axis direction in the drawings. The connecting portion 812 includes the ribbed grip 813 which serves as a reinforcement rib to mechanically strengthen the retainer 8 and an operator grasps when attaching the retainer 8 to or removing from the secondary assembly. The ribbed grip 813 protrudes from the connecting portion 812 in the negative Y-axis direction in the drawings and has a length extending in the width direction of the retainer body 81. The retainer 8 is shaped to be symmetrical with respect to a dividing plane which is defined to pass through the center of the width of the U-shaped retainer body 81 in parallel to a Y-Z plane in the drawings. FIG. 8C is a sectional view of the retainer 8 as taken along the dividing plane.

The retainer body 81 includes the connecting portion 812, the ribbed grip 813, and a pair of extensions 814. The extensions 814 are of an arm-shape and define straight sections of the U-shape of the retainer body 81. The extensions 814 extend from ends of the connecting portion 812 in the Z-axis direction in the drawings. The opening 811 is defined by top ends of the extensions 814. The extensions 814 have base ends (which will also be referred to below as second ends) which face away from the top ends (which will also be referred to below as first ends) thereof. The base ends of the extensions 813 are connected together by the connecting portion 812. The extensions 814 extend parallel to each other. The U-shape of the retainer body 81 is, therefore, defined by the connecting portion 812 and the extensions 814 which extend in a direction crossing the center axis line CL and are diametrically opposed to each other across the center axis line CL. The retainer body 81, as illustrated in FIGS. 8B and 8C, is substantially in an L- or J-shape, as viewed from the side thereof, which is defined by the ribbed grip 813 and the extensions 814. The retainer body 81 is, as described above, shaped to have the extensions 814 which define an inner space which faces the opening 811 and in which the cylinder 72 of the bezel 7 is disposed, thereby holding the cylinder 72 between the extensions 814.

Each of the extensions 814 includes the base plate 814a, the first reinforcement rib 814b, and the second reinforcement ribs 814c. The base plate 814a has a thickness in the axial direction of the ultrasonic sensor 1. The first reinforcement rib 814b and the second reinforcement ribs 814c serve to mechanically strengthen the base plate 814a of each of the extensions 814. The first reinforcement rib 814b of each of the extensions 814 is a rib which protrudes in the same direction as the ribbed grip 813 and extends along the length of a corresponding one of the extensions 814. The lengthwise direction of each of extensions 814 will also be referred to below as an extension direction. The extension direction coincides with the positive Z-axis direction in the drawings. The second reinforcement ribs 814c of each of the extensions 814 are ribs which protrude in the same direction as the first reinforcement rib 814b and extend outward in the width direction of the extension 814.

The extensions 84 are equipped with the guides 815. Each of the guides 815 is, as illustrated in FIGS. 8A and 8D, arranged inside a corresponding one of the first reinforcement ribs 814B of the retainer body 81 in the width direction of the retainer body 81. Each of the guides 815 is in a plate-shape having a thickness, as measured in a direction perpendicular to the Z-axis direction. Specifically, each of the guides 815 works to guide insertion of a corresponding one of the extensions 814 into a corresponding one of the retainer fit grooves 75b when the retainer 8 is attached to the bezel 7. Each of the guides 815 extends from the first reinforcement rib 814b into the above-described inner space facing the opening 811.

The retainer 8 is configured to have a variable degree of elasticity which is lower in an initial stage where the retainer 8 is inserted into the retainer fit grooves 75b, i.e., spaces between the retainer contact faces 75a and the inner bumper surface V32 than in a later stage. Specifically, each of the guides 815 includes the initially-inserted portion 816, the elasticity generating portion 817, and the holding portion 818. The initially-inserted portion 816, the elasticity generating portion 817, and the holding portion 818 are arranged in this order and aligned with each other in the extension direction. The initially-inserted portion 816 is formed on the top end or head of the guide 815 in the extension direction. The initially-inserted portion 816 is shaped to decrease a degree of elastic deformation of a corresponding one of the resilient members 82 when inserted into a corresponding one of the retainer fit grooves 75b and then faces the retainer contact face 75a in the axial direction to be lower than the elasticity generating portion 817. Specifically, the initially-inserted portion 816 of each of the guides 815 is, as can be seen in FIG. 8B, offset closer to the bumper, i.e., in the positive Y-axis direction in the drawings than the holding portion 818. This layout creates a level difference between the initially-inserted portion 816 and the holding portion 818 in the axial direction.

The elasticity generating portion 817 is arranged closer to the base end of the guide 815 than the initially-inserted portion 816 is in the extension direction. The elasticity generating portion 817 is configured to have the resilient members 82 generate an elastic force when the retainer 8 is moved in the retainer-inserting direction to be fitted in the bezel 7. Specifically, the elasticity generating portion 817 defines a slant flat shoulder connecting between the initially-inserted portion 816 and the holding portion 818. The holding portion 818 is in a flat plate shape having a thickness in the axial direction of the bezel 7. The holding portion 818 contacts a corresponding one of the retainer contact faces 75a of the bezel 7 in the bumper-mounted state to firmly hold the retainer 8 and the bezel 7 together.

Each of the guides 815 has the bezel contact surface 819 that is an outer surface thereof which faces in a direction opposite a direction in which the resilient members 82 protrude, that is, the negative Y-axis direction in the drawings. The bezel contact surfaces 819, which will also be referred to below as a housing contact surface, are contactable with the retainer fit grooves 75b, i.e., the retainer contact faces 75a in the axial direction when the retainer 8 is moved in the retainer-inserting direction and then attached to the bezel 7. Each of the bezel contact surface 819 includes the initially-inserted surface 819a (which will also be referred to below as a leading insertion surface), the slant surface portion 819b, and the flat surface portion 819c which are aligned with each other in the retainer-inserting direction.

The initially-inserted surface 819a which is formed on a top end portion of a corresponding one of the bezel contact surfaces 819 in the extension direction is defined by at least a portion of the initially-inserted portion 816. The initially-inserted surface 819a is offset from the flat surface portion 819c in the positive Y-axis direction in the drawings (i.e., the pressure-applying direction F in FIG. 9 which will also be referred to below as an elastic force-applying direction or an elastically urging direction). The initially-inserted surface 819a extends in the extension direction, i.e., the retainer-inserting direction. Specifically, the initially-inserted surface 819a is shaped as a tapered or slant surface which becomes away from the flat surface portion 819c in the axial direction of the bezel 7 as approaching in the extension direction, in other words, which slants downward in the pressure-applying direction F.

An intermediate portion of the bezel contact surface 819 in the extension direction defines the slant surface portion 819b disposed between the initially-inserted surface 819a and the flat surface portion 819c. The slant surface portion 819b occupies or coincides with at least a surface of the elasticity generating portion 817 in the extension direction. The slant surface portion 819b is of a slope shoulder shape connecting between the initially-inserted surface 819a and the flat surface portion 819c. In other words, the slant surface portion 819b is oriented downward or obliquely in the pressure-applying direction F toward the initially-inserted surface 819a. To say it in a different way, the slant surface portion 819b extends from the flat surface portion 819c to the initially-inserted surface 819 to slant in the pressure-applying direction F. Specifically, the slant surface portion 819b is steeper in gradient or inclination than the initially-inserted surface 819a. A joint between the initially-inserted surface 819a and the slant surface portion 819b, as can be seen in FIGS. 8A and 8C, creates the first bend 819d defined in the form of a valley-shaped recess by a difference in inclination between the initially-inserted surface 819a and the slant surface portion 819b.

The flat surface portion 819c is located closer to the base end of a corresponding one of the extensions 814 than the initially-inserted surface 819a is. The flat surface portion 819c has a length extending in the attachment-inserting direction. In other words, the flat surface portion 819c is aligned with the attachment-inserting direction. The flat surface portion 819c is a surface of the retainer 8 which makes physical contact with the retainer contact face 75a of the bezel 7 when the bumper-mounted state is established. The flat surface portion 819c is in the form of a smooth planar surface oriented to have a normal line parallel to the center axis line CL in the bumper-mounted state. Specifically, the flat surface portion 819c is oriented substantially parallel to the attachment-inserting direction. A joint between the slant surface portion 819b and the flat surface portion 819c, as can be seen in FIGS. 8A and 8C, creates the second bend 819e defined in the form of a valley-shaped recess by a difference in inclination between the slant surface portion 819b and the flat surface portion 819c. The slant surface portion 819b is arranged between the first bend 819d and the second bend 819e.

Each of the resilient members 82 is made of a leaf spring in the form of a cantilever and extends in the axial direction from a corresponding one of the extensions 814 of the retainer body 81. In the bumper-mounted state where the retainer 8 is firmly held by the retainer contact faces 75a of the bezel 7 and the inner bumper surface V32, each of the resilient members 82 is elastically deformed in physical contact with the inner bumper surface V32. Specifically, each of the resilient members 82 protrudes in the positive Y-axis direction in the drawings, i.e., away from the ribbed grip 813 and the first reinforcement rib 814b. When mechanically urged in the negative Y-axis direction in the drawings, each of the resilient members 82 is elastically deformed to generate an elastic force oriented in the positive Y-axis direction in the drawings, i.e., the pressure-applying direction F in FIG. 9.

As apparent from the above discussion, each of the resilient members 82 is shaped to create an elastic force oriented toward the bumper when the cylinder 72 of the bezel 7 is inserted into the mounting holes V5, and the retainer body 81 is fit in the retainer fit grooves 75b. The retainer 8 is thrusted in the attachment-inserting direction to slide in the retainer fit grooves 75b with the cylinder 72 disposed in the opening 811 and then firmly retained between the bumper and the cylinder 72 by means of the elastic force.

Each of the resilient members 82 extends from an intermediate portion of a length of a corresponding one of the extensions 814 and curves obliquely relative to the Y-axis direction. In other words, each of the extensions 814 has a respective two of the resilient members 82 which are in a gull-wing shape, as viewed in a lateral direction of the extensions 814. The retainer 8, therefore, has a total of four resilient members 82. More specifically, the retainer 8 has a first pair of front resilient members 821 and a second pair of rear resilient members 822. The front resilient member 821 of each of the extensions 814 extends or curves from an intermediate portion of a length of the extension 814 both in the positive Z-axis direction and in the positive Y-axis direction. Similarly, the rear resilient members 822 of each of the extensions 814 extends or curves from the intermediate portion of the length of the extension 814 both in the negative Z-axis direction and in Each of the front resilient the positive Y-axis direction. members 821 and the rear resilient members 822 is shaped to have a portion which is located slightly closer to the supported end than the free end is and curled in the form of an arch in the pressure-applying direction F.

### Beneficial Advantages

A method of attaching each of the ultrasonic sensors 1 to the bumper and the bumper-mounted state will be described below together with beneficial advantages offered by the unique structure of the ultrasonic sensors 1 with reference to the drawings. For the sake of simplicity of explanation, the attachment method or a sequence of steps thereof will be discussed using the right-handed Cartesian coordinate (X, Y, Z) system defined based on the illustrated vehicle-mounted state. The attachment or detachment of each of the ultrasonic sensors 1 to or from the bumper is achieved in a state where the bumper is removed from the vehicle body V1. In an actual attachment process, the positive Z-axis direction may, therefore, coincide with a direction other than the upward direction of the vehicle body V1.

First, the sensor body 2, as illustrated in FIG. 3, is assembled. The anti-vibration spacer 6 shown in FIGS. 5A and 5B is fitted into the spacer housing groove 71b and secured to the bezel 7. The ultrasonic microphone 4 and the cushion 5 of the sensor body 2 are then disposed inside the hollow cylindrical bezel 7 to which the anti-vibration spacer 6 is attached. This causes the bezel-fitting protrusions 37 of the microphone support 33 to be snap-fit in the snap-fit holes 74a in the sensor-fitting arms 74 of the cylinder 72, thereby securing the bezel 7 to the sensor body 2. In this way, the bezel 7 on which the anti-vibration spacer 6 is fit is attached to the sensor body 2, thereby completing the secondary assembly shown in FIG. 6. In the secondary assembly, the cushion 5 surrounds the ultrasonic microphone 4 and is disposed in the cylinder 72 of the bezel 7.

The secondary assembly shown in FIG. 6 is inserted at the connector 32 from the bumper-outside space SG into the mounting hole V5 until the anti-vibration spacer 6 physically contacts the outer bumper surface V31. While the cylinder 72 of the bezel 7 is being inserted into the mounting hole V5, the temporary assembling protrusions 76a contacts the cylindrical inner surface V51 of the mounting hole V5. This causes the free ends of the temporary assembling arms 76 to be elastically deformed inwardly, that is, toward the center axis line CL. When temporary assembling protrusions 76a have passed through the mounting holes V5, it will cause the elastic deformation of the temporary assembling arms 76 to be recovered. Such recovery causes, as can be seen in FIG. 9, the flange 71 and the temporary assembling protrusions 76a to firmly secure the bezel 7 to the bumper. This places the secondary assembly in the temporarily assembled state.

After the secondary assembly is placed in the temporarily assembled state in the above-described way, the retainer 8 is, as shown in FIG. 9, placed in an attaching orientation in the bumper-inside space SN. The attaching orientation of the retainer 8 is an orientation in which the opening 811 faces in the positive Z-axis direction in the drawings, and the resilient members 82 are positioned to face the inner bumper surface V32 before the retainer 8 is secured to the bezel 7, i.e., the secondary assembly.

Subsequently, the retainer 8 placed in the attaching orientation is moved in the retainer-inserting direction indicated by an arrow D in FIG. 9 to insert the bezel 7 of the secondary assembly in the temporarily assembled state into the opening 811. The retainer 8 is then thrusted in the retainer-inserting direction until the bezel 7 and the connecting portion 812 of the retainer 8 contact with each other or arrive close to each other. This causes the extensions 814 of the retainer 8 to slide in the retainer-inserting direction and then mechanically fit into the retainer fit grooves 75b formed in the bezel 7 of the secondary assembly, in other words, gaps or clearances between the retainer contact faces 75a and the inner bumper surface V32. In brief, the initially-inserted portion 816, the elasticity generating portion 817, the holding portion 818 of each of the extensions 814 are inserted in this order into a corresponding one of the retainer fit grooves 75b.

In the following discussion, a minimum distance or interval between each of the bezel contact surfaces 819 of the retainer 8 and a surface of a corresponding one of the resilient members 82 which makes a mechanical contact with the inner bumper surface V32 in a pressure-free state of the resilient members 82 illustrated in FIG. 9 where the resilient members 82 are placed in contact with the inner bumper surface V32 without being elastically deformed in the elastically urging direction F, i.e., before the resilient members 82 are elastically deformed in the pressure-applying direction F is defined as a contact-surface height H. The height (also called depth) of each of the retainer fit grooves 75b, i.e., a minimum distance between each of the retainer contact faces 75a of the bezel 7 and the inner bumper surface V32 is defined as a groove height H0. The contact-surface heigh H of the holding portion 818, i.e., the flat surface portion 819c meets a relation of H=H1>H0. Securing the stability in holding or attaching the retainer 8 to the secondary assembly placed in the temporarily assembled state with the retainer contact faces 75a of the bezel 7 abutting on the flat surface portions 819c of the retainer 8, therefore, requires a given degree of elastic deformation of the resilient members 82.

Each of the elasticity generating portions 817 (i.e., the slant surface portions 819b) is, as apparent from the above discussion, shaped to have the contact-surface height H which changes from a relation of H<H0 to a relation of H>H0 in a direction away from the top end of each of the guides 815. Accordingly, when each of the elasticity generating portions 817 is inserted into a corresponding one of the retainer fit grooves 75b, and the slant surface portion 819b of the bezel contact surface 819 contacts the retainer contact face 75a, it will cause the retainer body 81 to be mechanically urged in the pressure-applying direction F. This elastically deforms each of the resilient members 82 to move the free end thereof in a direction opposite the pressure-applying direction F. Such elastic deformation of each of the resilient members 82 will generate an elastic force in the form of a reactive force in the pressure-applying direction F. Subsequently, when the retainer 8 is thrusted until the flat surface portions 819c of the bezel contact surfaces 819 make stable contacts with the retainer contact faces 75a, the retainer 8 is firmly held between the base end protrusions 75 of the bezel 7 and the inner bumper surface V32 by means of the elastic force generated by the resilient members 82. The retainer 8 is attached to the secondary assembly placed in the temporarily assembled state in the above way, thereby completing the bumper-mounted state or the vehicle-mounted state where each of the ultrasonic sensors 1 is, as illustrated in FIG. 2, fit in the front bumper V3. The attachment of the ultrasonic sensors 1 to the rear bumper V4 is achieved in the same way as described above.

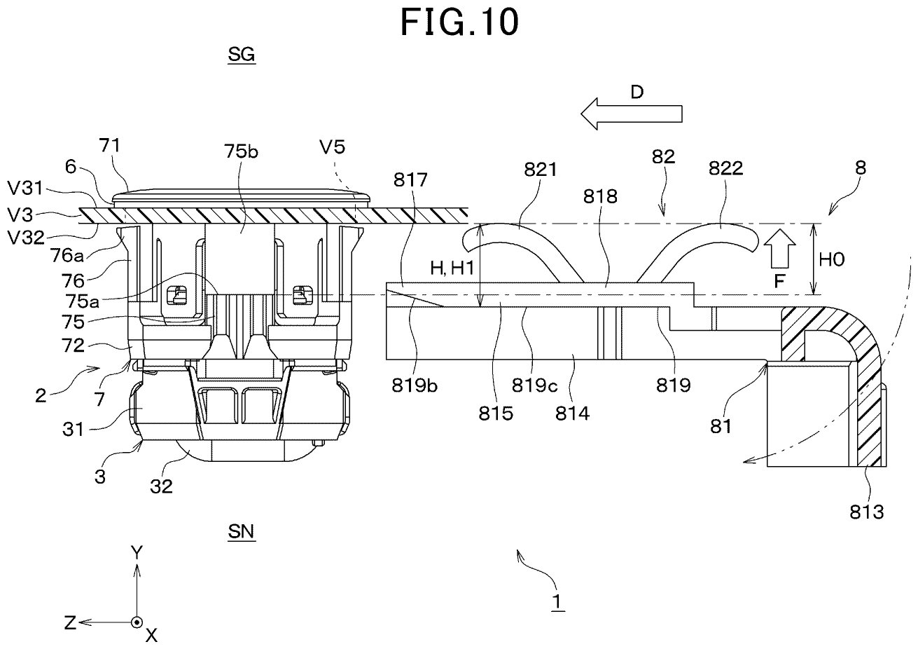

FIG. 10 demonstrates a comparative example where each of the extensions 814 is designed not to have the initially-inserted portion 816, i.e., the elasticity generating portion 817 which serves to elastically deform a corresponding one of the resilient members 82 is formed by the top end portion of each of the extensions 815. This structure requires the retainer 8 to be inclined or tilted, as indicated by a dash-double-dot line in FIG. 10, to have the top end of each of the extensions 814 move toward the inner bumper surface V32 in the attaching orientation in order to insert the top ends of the extensions 814 into the retainer fit grooves 75b. The retainer 8, therefore, needs to be thrusted in the retainer-inserting direction with the resilient members 82 elastically deformed while the lengths of the extensions 814 are kept tilted relative to the retainer-inserting direction. Such attaching orientation usually results in instability of the tilt of the retainer 8, in other words, a risk that a direction in which a mechanical load is exerted on the resilient members 82 to create elastic deformation thereof may be changed. This may trigger operator errors in setting a direction in which the load is exerted on the resilient members 82 or result in an excess of load acting on the resilient members 82. There is, therefore, room for improvement in work efficiency in attaching the retainer 8 to the bezel 7.

The structure in this embodiment is, as can be seen in FIG. 9, designed to have the initially-inserted portion 816 provided on a portion of each of the extensions 815 which is located closer to the top end of the extension 815 than the elasticity generating portion 817 is. The elasticity generating portion 817, as already described, serves to elastically deform the resilient member 82. The initially-inserted portion 816 is shaped to have a portion whose contact-surface height H is smaller than that of the elasticity generating portion 817. Specifically, the retainer 8 is configured to have the resilient members 82 each producing a degree of elastic force which is higher in an initial stage of insertion of the initially-inserted portions 816 into the retainer fit grooves 75b than in a subsequent state of insertion of the elasticity generating portions 817 into the retainer fit grooves 75b. In other words, each of the extensions 814, i.e., the guides 815 makes the resilient members 82 generate a degree of elastic force changing stepwise by means of the initially-inserted portion 816, the elasticity generating portion 817, and the holding portion 818. More specifically, the initially-inserted surface 819a of the initially-inserted portion 816 of each of the extensions 815 is located closer to the inner bumper surface V32 than the slant surface portion 819b of the elasticity generating portion 817 is in the attaching orientation of the retainer 8. It is preferable that each of the guides 815 is designed to have the initially-inserted portion 816 which makes the resilient members 82 generate no elastic force when the retainer 8 is thrusted in the retainer-inserting direction with the resilient members 82 kept contacting the inner bumper surface V32 in the attaching orientation of the retainer 8. More specifically, each of the initially-inserted portions 816 is offset away from the resilient members 82 in the axial direction of the bezel 7 sufficiently to have the contact-surface height H meeting a relation of H<H0 as a whole in order to make the resilient members 82 generate no elastic force when the initially-inserted portions 816 are inserted into the retainer fit grooves 75b.

The above-described structure enables an angle at which the retainer 8 is required to be tilted in the attaching orientation of the retainer 8 to be decreased. In other words, the above-described structure, as can be seen in FIG. 9, eliminates the need for tilting the retainer 8 in the attaching orientation. This enables a degree of mechanical load required to thrust the retainer 8 into the retainer fit grooves 75b at the initial stage to be decreased. It, therefore, makes it possible to press the retainer 8 in the retainer-inserting direction in a stable orientation, thereby ensuring the stability in attaching the retainer 8 to the bezel 7. Additionally, the degree of load required to elastically deform the resilient members 82 to be minimized. This embodiment, therefore, improves the workability in mounting each of the ultrasonic sensors 1 in the bumper of the vehicle V.

In the bumper-mounted state or the vehicle-mounted state, the cushion 5, the anti-vibration spacer 6, and the bezel 7 of each of the ultrasonic sensors 1 are disposed between the ultrasonic microphone 4 and the bumper. Specifically, the cushion 5 is held between the ultrasonic microphone 4 and the bezel 7. Additionally, the anti-vibration spacer 6 is held between the flange 71 of the bezel 7 and the bumper. Furthermore, the retainer 8 includes the initially-inserted portions 816 which serve to facilitate establishing the bumper-mounted state or the vehicle-mounted state by means of elastic joints of the holding portions 818 to the retainer contact faces 75a which are achieved by the resilient members 82 after the retainer 8 is mounted onto the secondary assembly in the temporarily assembled state with improved workability. The structure of the ultrasonic sensors 1 according to this embodiment, therefore, eliminates a risk that sensing errors may be caused by transmission of mechanical vibration from the bumper to the ultrasonic sensors 1 especially when the bumper is made from metallic material which is high in transmission of mechanical vibration.

### Modifications

This disclosure is not limited to the above embodiment, but may be modified in various ways. The following discussion will refer to modifications of the embodiment. The same or similar parts of the ultrasonic sensors 1 as described above will be indicated by same or similar reference numbers or symbols, and explanation thereof in detail will be omitted here unless there is a technical inconsistency or a need for specific additional explanation.

For the sake of simplicity of illustration or description, the above discussion has referred to the ultrasonic sensors 1 mounted on the front bumper V3, but however, the present disclosure is not limited to the above-described embodiment. It can be easily understood from the description of the above embodiment that the ultrasonic sensors 1 and the configurations of their respective parts may be mounted on the rear bumper V4.

An object on which the ultrasonic sensors 1 are mounted is not limited to the front bumper V3 or the rear bumper V4. For instance, the ultrasonic sensors 1 may be attached to the body panel V2. In other words, the mounting holes V5 may be formed in the body panel V2.

The ultrasonic sensors 1 are not limited to a configuration capable of both transmitting and receiving ultrasonic waves. For example, the ultrasonic sensors 1 may have a configuration that allows only the transmission of ultrasonic waves. Alternatively, the ultrasonic sensors 1 may have only a receiving function for receiving reflected waves from objects in the surroundings, the reflected waves being from radar waves transmitted by another ultrasonic transmitter.

The configuration of each component of the ultrasonic sensors 1 is not limited to the foregoing embodiment. Specifically, the materials constituting each component may be appropriately modified from those described in the foregoing embodiment. Further, a plurality of components formed from the same material may instead be formed from different materials. Conversely, a plurality of components formed from different materials may instead be formed from the same material. Moreover, a plurality of components integrally formed without joints may instead be formed by bonding separate or discrete members together. Conversely, a plurality of components formed by bonding separate members together may instead be integrally formed without joints.

The structure of the sensor case 3 is not limited to the foregoing embodiment. For example, the structure and extension direction of the connector 32 may be appropriately modified. Furthermore, the shape of the microphone support 33 is not limited to a substantially cylindrical shape, and may alternatively be a substantially elliptical cylindrical shape, a substantially elongated cylindrical shape, a substantially polygonal cylindrical shape, or the like.

The external shape of the ultrasonic microphone 4, i.e., the microphone case 42, is not limited to a substantially cylindrical shape, and may alternatively be a substantially elliptical cylindrical shape, a substantially regular polygonal cylindrical shape, or the like. The electro-mechanical transducer constituting the ultrasonic device 41 is not limited to a piezoelectric device, and may be any suitable type of transducer.

The structure of the cushion 5 is also not limited to the foregoing embodiments. For instance, the shape of the cushion 5 is not restricted to a substantially cylindrical shape, and may alternatively be a substantially elliptical cylindrical shape, a substantially elongated cylindrical shape, a substantially polygonal cylindrical shape, or the like.

The cushion 5 may, like the bezel 7, be configured to constitute the secondary assembly by being attached subsequently to the sensor body 2, which constitutes the primary assembly. In this case, the ultrasonic microphone 4 may be supported by the microphone support 33 of the sensor case 3 without the cushion 5 being interposed therebetween. Furthermore, the cushion 5 may be formed into a tubular shape having an axial dimension substantially identical to the axial dimension of the ultrasonic microphone 4, i.e., the microphone case 42.

The structures of parts, i.e., the bezel 7 and the retainer 8 of the ultrasonic sensors 1 used to attach the ultrasonic sensors 1 to a vehicle body member, e.g., the front bumper V3 are not limited to the above-described examples. For example, detailed configurations of the bezel 7 and/or the retainer 8 may be appropriately modified from the above-described embodiment as necessary. The present disclosure is also not limited to a configuration in which the sensor body 2 is mounted to a vehicle body component using the bezel 7 and the retainer 8. For example, the bezel 7 may be integrally formed with the sensor body 2 in a non-detachable manner. In other words, the present disclosure is also suitably applicable to so-called bezel-less configurations.

The stability of the attaching orientation or attaching workability of the retainer 8 may also be achieved by selecting the degree of elastic force generated by the front resilient members 821 to be lower than that generated by the rear resilient members 822. For instance, the front resilient members 821 may be formed thinner and/or narrower than the rear resilient members 822. Herein, “thinner” refers to having a smaller dimension in the X-axis direction in the drawings, and “narrower” refers to having a smaller width dimension in a side view as shown in FIGS. 8B, 9, and 10. The width dimension of the front resilient members 821 and the rear resilient members 822 refers to the dimension in the direction orthogonal both to the tangential direction of the elastic portion centerline and to the X-axis direction. The “elastic portion centerline” refers to a virtual curve passing through the center of each of the front resilient members 821 or each of the rear resilient members 822 along the arch shape extending from the supported end to the free end thereof. For instance, each of the front resilient members 821 may be shaped to have a length which extends from the supported end thereof to a portion thereof contacting the inner bumper surface V32 and is longer than that of each of the rear resilient members 822. Such a structure may be used in the retainer 8, as illustrated in FIG. 10, which does not have the initially-inserted portions 816.

The component parts described in the above-described embodiment are not necessarily essential unless otherwise specified or viewed to be essential in principle. When the number of the component parts, numerical numbers, volumes, or ranges are referred to in the above discussion, this disclosure is not limited to it unless otherwise specified or viewed to be essential in principle. Similarly, when the shape of, the orientation of, or the positional relation among the component parts is referred to in the above discussion, this disclosure is not limited to it unless otherwise specified or viewed to be essential in principle. Similarly, when the shape of, orientation of, or a positional relation between or among the component parts, this disclosure is not limited to it unless otherwise specified or viewed to be essential in principle.

The above modifications are also not limited to the above described examples. A portion or whole of the embodiment may be combined with one or some of the modifications unless there is a technical inconsistency or a need for specific additional explanation.

### DISCLOSED ASPECTS

As apparent from the above discussion of the embodiment and the modifications, this application discloses the following unique aspects.

### Aspect 1-1

A sensor attachment (8) is provided which is used in attaching an ultrasonic sensor (1) to a plate-like vehicle body component (V3). The ultrasonic sensor includes a hollow cylindrical housing member (7) which has a cylinder (72) and a flange (71) functioning as a stopper. The cylinder is configured to be inserted into a through-hole (V5) formed in the vehicle body component. The cylinder has a first end and a second end opposed to the first end in an axial direction parallel to a center axis line (CL) thereof. The flange is formed on the first end and shaped to protrude away from the center axis line in a radial direction of the cylinder. The cylinder has a pair of attachment fit grooves (75) formed in an outer periphery thereof. The attachment fit grooves open in the radial direction of the cylinder and extend in an attachment-inserting direction (D) crossing the radial direction of the cylinder, the attachment fit grooves extending parallel to each other on both sides of the center axis line. The sensor attachment comprises (a) an attachment body (81) which is of a U-shape and includes a pair of extensions (814), a connecting portion (812), and an opening (811), the extensions extending parallel to each other in the attachment-inserting direction and each having a top end and a base end opposed to the top end in the attachment-inserting direction, the connecting portion extending to connect the base ends of the extensions together, the opening being shaped to open at the top ends of the extensions; and (b) resilient members (82) which protrude from the attachment body in the axial direction and are shaped to be elastically deformable in the axial direction to generate elastic force in an elastically urging direction (F) oriented toward the vehicle body component in a condition where the cylinder is inserted into the through-hole, and the attachment body is fit in the attachment fit grooves. The resilient members work to generate the elastic force to hold the sensor attachment between the vehicle body component and the cylinder by inserting the extensions of the attachment body into the attachment fit grooves to slide in the attachment-inserting direction and to have the cylinder disposed within the opening in a condition where the cylinder is inserted into the through-hole. The resilient members are configured to produce the elastic force which is lower at an initial stage of insertion of the extensions into the attachment fit grooves than at a subsequent stage of the insertion of the extensions following the initial stage.

### Aspect 1-2

The sensor attachment as set forth in the aspect 1-1, wherein each of the extensions of the attachment body includes an initially-inserted portion (816) which is provided at the top end thereof and an elasticity generating portion (817) which is located closer to the base end than the initially-inserted portion is. The initially-inserted portion of each of the extensions is configured to induce a degree of elastic deformation of a corresponding one of the resilient members to be lower than that induced by a corresponding one of the elasticity generating portions.

### Aspect 1-3

A sensor attachment (8) is provided which is used in attaching an ultrasonic sensor (1) to a plate-like vehicle body component (V3). The ultrasonic sensor includes a hollow cylindrical housing member (7) which has a cylinder (72) and a flange (71) functioning as a stopper. The cylinder is configured to be inserted into a through-hole (V5) formed in the vehicle body component. The cylinder has a first end and a second end opposed to the first end in an axial direction parallel to a center axis line (CL) thereof. The flange is formed on the first end and shaped to protrude away from the center axis line in a radial direction of the cylinder. The cylinder has a pair of attachment fit grooves (75) formed in an outer periphery thereof. The attachment fit grooves open in the radial direction of the cylinder and extend in an attachment-inserting direction (D) crossing the radial direction of the cylinder, the attachment fit grooves extending parallel to each other on both sides of the center axis line. The sensor attachment comprises (a) an attachment body (81) which is of a U-shape and includes a pair of extensions (814), a connecting portion (812), and an opening (811), the extensions extending parallel to each other in the attachment-inserting direction and each having a top end and a base end opposed to the top end in the attachment-inserting direction, the connecting portion extending to connect the base ends of the extensions together, the opening being shaped to open at the top ends of the extensions; and (b) resilient members (82) which protrude from the attachment body in the axial direction and are shaped to be elastically deformable in the axial direction to generate elastic force in an elastically urging direction (F) oriented toward the vehicle body component in a condition where the cylinder is inserted into the through-hole, and the attachment body is fit in the attachment fit grooves. The resilient members work to generate the elastic force to hold the sensor attachment between the vehicle body component and the cylinder by inserting the extensions of the attachment body into the attachment fit grooves to slide in the attachment-inserting direction and to have the cylinder disposed within the opening in a condition where the cylinder is inserted into the through-hole. Each of the extensions of the attachment body includes an initially-inserted portion (816) which is provided at the top end thereof and an elasticity generating portion (817) which is located closer to the base end than the initially-inserted portion is. The initially-inserted portion of each of the extensions is configured to induce a degree of elastic deformation of a corresponding one of the resilient members to be lower than that induced by a corresponding one of the elasticity generating portions.

### Aspect 1-4

The sensor attachment as set forth in one of the above aspects 1-1 to 1-3, wherein the attachment body has housing contact surfaces (819) which face in the axial direction and are configured to make contacts with the attachment fit grooves in the axial direction. Each of the housing contact surfaces includes an initially-inserted surface (819a), a flat surface portion (819c), and a slant surface portion (819b). The initially-inserted surface (819a) is located on the top end of a corresponding one of the extensions. The flat surface portion is located closer to the base end of a corresponding one of the extensions than the initially-inserted surface is. The slant surface portion (819b) is located between the initially-inserted surface and the flat surface portion. The initially-inserted surface and the flat surface portion are aligned with each other in the attachment-inserting direction. The initially-inserted surface is offset from the flat surface portion in the elastically urging direction. The slant surface portion extends from the flat surface portion to the initially-inserted surface to slant in the elastically urging direction.

### Aspect 1-5

A sensor attachment (8) is provided which is used in attaching an ultrasonic sensor (1) to a plate-like vehicle body component (V3). The ultrasonic sensor includes a hollow cylindrical housing member (7) which has a cylinder (72) and a flange (71) functioning as a stopper. The cylinder is configured to be inserted into a through-hole (V5) formed in the vehicle body component. The cylinder has a first end and a second end opposed to the first end in an axial direction parallel to a center axis line (CL) thereof. The flange is formed on the first end and shaped to protrude away from the center axis line in a radial direction of the cylinder. The cylinder has a pair of attachment fit grooves (75) formed in an outer periphery thereof. The attachment fit grooves open in the radial direction of the cylinder and extend in an attachment-inserting direction (D) crossing the radial direction of the cylinder, the attachment fit grooves extending parallel to each other on both sides of the center axis line. The sensor attachment comprises (a) an attachment body (81) which is of a U-shape and includes a pair of extensions (814), a connecting portion (812), and an opening (811), the extensions extending parallel to each other in the attachment-inserting direction and each having a top end and a base end opposed to the top end in the attachment-inserting direction, the connecting portion extending to connect the base ends of the extensions together, the opening being shaped to open at the top ends of the extensions; and (b) resilient members (82) which protrude from the attachment body in the axial direction and are shaped to be elastically deformable in the axial direction to generate elastic force in an elastically urging direction (F) oriented toward the vehicle body component in a condition where the cylinder is inserted into the through-hole, and the attachment body is fit in the attachment fit grooves. The resilient members work to generate the elastic force to hold the sensor attachment between the vehicle body component and the cylinder by inserting the extensions of the attachment body into the attachment fit grooves to slide in the attachment-inserting direction and to have the cylinder disposed within the opening in a condition where the cylinder is inserted into the through-hole. The attachment body has housing contact surfaces (819) which face in the axial direction and are configured to make contacts with the attachment fit grooves in the axial direction. Each of the housing contact surfaces includes an initially-inserted surface (819a), a flat surface portion (819c), and a slant surface portion (819b). The initially-inserted surface (819a) is located on the top end of a corresponding one of the extensions. The flat surface portion is located closer to the base end of a corresponding one of the extensions than the initially-inserted surface is. The slant surface portion (819b) is located between the initially-inserted surface and the flat surface portion. The initially-inserted surface and the flat surface portion are aligned with each other in the attachment-inserting direction. The initially-inserted surface is offset from the flat surface portion in the elastically urging direction. The slant surface portion extends from the flat surface portion to the initially-inserted surface to slant in the elastically urging direction.

### Aspect 2-1

An ultrasonic sensor (1) is provided which is configured to be attached to a plate-like vehicle body component (V3). The ultrasonic sensor comprises a hollow cylindrical housing member (7) and a sensor attachment (8). The housing member has a cylinder (72) and a flange (71) functioning as a stopper. The cylinder is configured to be inserted into a through-hole (V5) formed in the vehicle body component. The cylinder has a first end and a second end opposed to the first end in an axial direction parallel to a center axis line (CL) thereof. The flange is formed on the first end of the cylinder and shaped to protrude away from the center axis line in a radial direction of the cylinder. The sensor attachment is configured to be fit on the housing member to retain the housing member on the vehicle body component. The cylinder has a pair of attachment fit grooves (75) formed in an outer periphery thereof. The attachment fit grooves open in the radial direction of the cylinder and extend in an attachment-inserting direction (D) crossing the radial direction of the cylinder. The attachment fit grooves extend parallel to each other on both sides of the center axis line. The sensor attachment comprises an attachment body (81) and resilient members (82). The attachment body is of a U-shape and includes a pair of extensions (814), a connecting portion (812), and an opening (811). The extensions extend parallel to each other in the attachment-inserting direction, each having a top end and a base end opposed to the top end in the attachment-inserting direction. The connecting portion extends to connect the base ends of the extensions together. The opening is shaped to open at the top ends of the extensions. The resilient members protrude from the attachment body in the axial direction and are shaped to be elastically deformable in the axial direction to generate elastic force in an elastically urging direction (F) oriented toward the vehicle body component in a condition where the cylinder is inserted into the through-hole, and the attachment body is fit in the attachment fit grooves. The resilient members work to generate the elastic force to hold the sensor attachment between the vehicle body component and the cylinder by inserting the extensions of the attachment body into the attachment fit grooves to slide in the attachment-inserting direction and to have the cylinder disposed within the opening in a condition where the cylinder is inserted into the through-hole. The resilient members are configured to produce the elastic force which is lower at an initial stage of insertion of the extensions into the attachment fit grooves than at a subsequent stage of the insertion of the extensions following the initial stage.

### Aspect 2-2

The ultrasonic sensor as set forth in the aspect 2-1, wherein each of the extensions of the attachment body includes an initially-inserted portion (816) which is provided at the top end thereof and an elasticity generating portion (817) which is located closer to the base end than the initially-inserted portion is. The initially-inserted portion of each of the extensions is configured to induce a degree of elastic deformation of a corresponding one of the resilient members to be lower than that induced by a corresponding one of the elasticity generating portions.

### Aspect 2-3

An ultrasonic sensor (1) is provided which is configured to be attached to a plate-like vehicle body component (V3). The ultrasonic sensor comprises a hollow cylindrical housing member (7) and a sensor attachment (8). The housing member has a cylinder (72) and a flange (71) functioning as a stopper. The cylinder is configured to be inserted into a through-hole (V5) formed in the vehicle body component. The cylinder has a first end and a second end opposed to the first end in an axial direction parallel to a center axis line (CL) thereof. The flange is formed on the first end of the cylinder and shaped to protrude away from the center axis line in a radial direction of the cylinder. The sensor attachment is configured to be fit on the housing member to retain the housing member on the vehicle body component. The cylinder has a pair of attachment fit grooves (75) formed in an outer periphery thereof. The attachment fit grooves open in the radial direction of the cylinder and extend in an attachment-inserting direction (D) crossing the radial direction of the cylinder. The attachment fit grooves extend parallel to each other on both sides of the center axis line. The sensor attachment comprises an attachment body (81) and resilient members (82). The attachment body is of a U-shape and includes a pair of extensions (814), a connecting portion (812), and an opening (811). The extensions extend parallel to each other in the attachment-inserting direction, each having a top end and a base end opposed to the top end in the attachment-inserting direction. The connecting portion extends to connect the base ends of the extensions together. The opening is shaped to open at the top ends of the extensions. The resilient members protrude from the attachment body in the axial direction and are shaped to be elastically deformable in the axial direction to generate elastic force in an elastically urging direction (F) oriented toward the vehicle body component in a condition where the cylinder is inserted into the through-hole, and the attachment body is fit in the attachment fit grooves. The resilient members work to generate the elastic force to hold the sensor attachment between the vehicle body component and the cylinder by inserting the extensions of the attachment body into the attachment fit grooves to slide in the attachment-inserting direction and to have the cylinder disposed within the opening in a condition where the cylinder is inserted into the through-hole. Each of the extensions of the attachment body includes an initially-inserted portion (816) which is provided at the top end thereof and an elasticity generating portion (817) which is located closer to the base end than the initially-inserted portion is. The initially-inserted portion of each of the extensions is configured to induce a degree of elastic deformation of a corresponding one of the resilient members to be lower than that induced by a corresponding one of the elasticity generating portions.

### Aspect 2-4

The ultrasonic sensor as set forth in one of the above aspects 2-1 to 2-3, wherein the attachment body has housing contact surfaces (819) which face in the axial direction and are configured to make contacts with the attachment fit grooves in the axial direction. Each of the housing contact surfaces includes an initially-inserted surface (819a), a flat surface portion (819c), and a slant surface portion (819b). The initially-inserted surface (819a) is located on the top end of a corresponding one of the extensions. The flat surface portion is located closer to the base end of a corresponding one of the extensions than the initially-inserted surface is. The slant surface portion (819b) is located between the initially-inserted surface and the flat surface portion. The initially-inserted surface and the flat surface portion are aligned with each other in the attachment-inserting direction. The initially-inserted surface is offset from the flat surface portion in the elastically urging direction. The slant surface portion extends from the flat surface portion to the initially-inserted surface to slant in the elastically urging direction.

### Aspect 2-5

An ultrasonic sensor (1) is provided which is configured to be attached to a plate-like vehicle body component (V3). The ultrasonic sensor comprises a hollow cylindrical housing member (7) and a sensor attachment (8). The housing member has a cylinder (72) and a flange (71) functioning as a stopper. The cylinder is configured to be inserted into a through-hole (V5) formed in the vehicle body component. The cylinder has a first end and a second end opposed to the first end in an axial direction parallel to a center axis line (CL) thereof. The flange is formed on the first end of the cylinder and shaped to protrude away from the center axis line in a radial direction of the cylinder. The sensor attachment is configured to be fit on the housing member to retain the housing member on the vehicle body component. The cylinder has a pair of attachment fit grooves (75) formed in an outer periphery thereof. The attachment fit grooves open in the radial direction of the cylinder and extend in an attachment-inserting direction (D) crossing the radial direction of the cylinder. The attachment fit grooves extend parallel to each other on both sides of the center axis line. The sensor attachment comprises an attachment body (81) and resilient members (82). The attachment body is of a U-shape and includes a pair of extensions (814), a connecting portion (812), and an opening (811). The extensions extend parallel to each other in the attachment-inserting direction, each having a top end and a base end opposed to the top end in the attachment-inserting direction. The connecting portion extends to connect the base ends of the extensions together. The opening is shaped to open at the top ends of the extensions. The resilient members protrude from the attachment body in the axial direction and are shaped to be elastically deformable in the axial direction to generate elastic force in an elastically urging direction (F) oriented toward the vehicle body component in a condition where the cylinder is inserted into the through-hole, and the attachment body is fit in the attachment fit grooves. The resilient members work to generate the elastic force to hold the sensor attachment between the vehicle body component and the cylinder by inserting the extensions of the attachment body into the attachment fit grooves to slide in the attachment-inserting direction and to have the cylinder disposed within the opening in a condition where the cylinder is inserted into the through-hole. The attachment body has housing contact surfaces (819) which face in the axial direction and are configured to make contacts with the attachment fit grooves in the axial direction. Each of the housing contact surfaces includes an initially-inserted surface (819a), a flat surface portion (819c), and a slant surface portion (819b). The initially-inserted surface (819a) is located on the top end of a corresponding one of the extensions. The flat surface portion is located closer to the base end of a corresponding one of the extensions than the initially-inserted surface is. The slant surface portion (819b) is located between the initially-inserted surface and the flat surface portion. The initially-inserted surface and the flat surface portion are aligned with each other in the attachment-inserting direction. The initially-inserted surface is offset from the flat surface portion in the elastically urging direction. The slant surface portion extends from the flat surface portion to the initially-inserted surface to slant in the elastically urging direction.

What is claimed is:

1. A sensor attachment (8) for use in attaching an ultrasonic sensor (1) to a plate-like vehicle body component (V3), the ultrasonic sensor including a hollow cylindrical housing member (7) which has a cylinder (72) and a flange (71) functioning as a stopper, the cylinder being configured to be inserted into a through-hole (V5) formed in the vehicle body component, the cylinder having a first end and a second end opposed to the first end in an axial direction parallel to a center axis line (CL) thereof, the flange being formed on the first end and shaped to protrude away from the center axis line in a radial direction of the cylinder, the cylinder having a pair of attachment fit grooves (75) formed in an outer periphery thereof, the attachment fit grooves opening in the radial direction of the cylinder and extending in an attachment-inserting direction (D) crossing the radial direction of the cylinder, the attachment fit grooves extending parallel to each other on both sides of the center axis line, the sensor attachment comprising:
an attachment body (81) which is of a U-shape and includes a pair of extensions (814), a connecting portion (812), and an opening (811), the extensions extending parallel to each other in the attachment-inserting direction and each having a top end and a base end opposed to the top end in the attachment-inserting direction, the connecting portion extending to connect the base ends of the extensions together, the opening being shaped to open at the top ends of the extensions; and
resilient members (82) which protrude from the attachment body in the axial direction and are shaped to be elastically deformable in the axial direction to generate elastic force in an elastically urging direction (F) oriented toward the vehicle body component in a condition where the cylinder is inserted into the through-hole, and the attachment body is fit in the attachment fit grooves, wherein
the resilient members work to generate the elastic force to hold the sensor attachment between the vehicle body component and the cylinder by inserting the extensions of the attachment body into the attachment fit grooves to slide in the attachment-inserting direction and to have the cylinder disposed within the opening in a condition where the cylinder is inserted into the through-hole, and
the attachment body has housing contact surfaces (819) which face in the axial direction and are configured to make contacts with the attachment fit grooves in the axial direction,
each of the housing contact surfaces includes an initially-inserted surface (819a), a flat surface portion (819c), and a slant surface portion (819b),
the initially-inserted surface (819a) is located on the top end of a corresponding one of the extensions,
the flat surface portion is located closer to the base end of a corresponding one of the extensions than the initially-inserted surface is,
the slant surface portion (819b) is located between the initially-inserted surface and the flat surface portion,
the initially-inserted surface and the flat surface portion are aligned with each other in the attachment-inserting direction,
the initially-inserted surface is offset from the flat surface portion in the elastically urging direction, and
the slant surface portion extends from the flat surface portion to the initially-inserted surface to slant in the elastically urging direction.

2. The sensor attachment as set forth in claim 1, wherein each of the extensions of the attachment body includes an initially-inserted portion (816) which is provided at the top end thereof and an elasticity generating portion (817) which is located closer to the base end than the initially-inserted portion is, and
the initially-inserted portion of each of the extensions is configured to induce a degree of elastic deformation of a corresponding one of the resilient members to be lower than that induced by a corresponding one of the elasticity generating portions.

3. The sensor attachment as set forth in claim 2, wherein each of the initially-inserted portions has the initially-inserted surface,
each of the resilient members has the slant surface portion,
the vehicle body component has a contact surface (V32) which makes a physical contact with each of the resilient members in a condition where the cylinder is inserted into the through-hole,
each of the attachment fit grooves of the cylinder has a retainer contact surface (75a) that is an end surface thereof located away from the first end of the cylinder in the axial direction,
a distance between the contact surface of the vehicle body component and the retainer contact surface in the axial direction in the condition where the cylinder is inserted into the through-hole is defined as H0,
a distance between each of the retainer contact surfaces and a corresponding one of the housing contact surfaces (819) in a pressure-free state where the resilient members are placed in contact with the contact surface of the vehicle body component without being elastically deformed in the elastically urging direction is defined as H,
each of the initially-inserted surfaces is shaped to meet a relation of H<H0,
each of the slant surface portions is configured to change from a relation of H<H0 to a relation of H >H0, and
each of the flat surface portions is shaped to meet a relation of H>H0.

4. The sensor attachment as set forth in claim 3, wherein each of the initially-inserted portions extends from a corresponding one of the resilient members in the attachment-inserting direction and is shaped to be smaller in inclination than a corresponding one of the slant surface portions.

5. An ultrasonic sensor (1) which is configured to be attached to a plate-like vehicle body component (V3), comprising a hollow cylindrical housing member (7) and a sensor attachment (8), the housing member having a cylinder (72) and a flange (71) functioning as a stopper, the cylinder being configured to be inserted into a through-hole (V5) formed in the vehicle body component, the cylinder having a first end and a second end opposed to the first end in an axial direction parallel to a center axis line (CL) thereof, the flange being formed on the first end of the cylinder and shaped to protrude away from the center axis line in a radial direction of the cylinder,
the sensor attachment is configured to be fit on the housing member to retain the housing member on the vehicle body component,
the cylinder has a pair of attachment fit grooves (75) formed in an outer periphery thereof, the attachment fit grooves opening in the radial direction of the cylinder and extending in an attachment-inserting direction (D) crossing the radial direction of the cylinder, the attachment fit grooves extending parallel to each other on both sides of the center axis line,
the sensor attachment comprises an attachment body (81) and resilient members (82), the attachment body being of a U-shape and including a pair of extensions (814), a connecting portion (812), and an opening (811), the extensions extending parallel to each other in the attachment-inserting direction and each having a top end and a base end opposed to the top end in the attachment-inserting direction, the connecting portion extending to connect the base ends of the extensions together, the opening being shaped to open at the top ends of the extensions,
the resilient members protrude from the attachment body in the axial direction and are shaped to be elastically deformable in the axial direction to generate elastic force in an elastically urging direction (F) oriented toward the vehicle body component in a condition where the cylinder is inserted into the through-hole, and the attachment body is fit in the attachment fit grooves,
the resilient members work to generate the elastic force to hold the sensor attachment between the vehicle body component and the cylinder by inserting the extensions of the attachment body into the attachment fit grooves to slide in the attachment-inserting direction and to have the cylinder disposed within the opening in a condition where the cylinder is inserted into the through-hole,
the attachment body has housing contact surfaces (819) which face in the axial direction and are configured to make contacts with the attachment fit grooves in the axial direction,
each of the housing contact surfaces includes an initially-inserted surface (819a), a flat surface portion (819c), and a slant surface portion (819b),
the initially-inserted surface (819a) is located on the top end of a corresponding one of the extensions,
the flat surface portion is located closer to the base end of a corresponding one of the extensions than the initially-inserted surface is,
the slant surface portion (819b) is located between the initially-inserted surface and the flat surface portion,
the initially-inserted surface and the flat surface portion are aligned with each other in the attachment-inserting direction,
the initially-inserted surface is offset from the flat surface portion in the elastically urging direction, and
the slant surface portion extends from the flat surface portion to the initially-inserted surface to slant in the elastically urging direction.

6. The ultrasonic sensor as set forth in claim 5, wherein each of the extensions of the attachment body includes an initially-inserted portion (816) which is provided at the top end thereof and an elasticity generating portion (817) which is located closer to the base end than the initially-inserted portion is, and
the initially-inserted portion of each of the extensions is configured to induce a degree of elastic deformation of a corresponding one of the resilient members to be lower than that induced by a corresponding one of the elasticity generating portions.

7. The sensor attachment as set forth in claim 6, wherein each of the initially-inserted portions has the initially-inserted surface,
each of the resilient members has the slant surface portion,
the vehicle body component has a contact surface (V32) which makes a physical contact with each of the resilient members in a condition where the cylinder is inserted into the through-hole,
each of the attachment fit grooves of the cylinder has a retainer contact surface (75a) that is an end surface thereof located away from the first end of the cylinder in the axial direction,
a distance between the contact surface of the vehicle body component and the retainer contact surface in the axial direction in the condition where the cylinder is inserted into the through-hole is defined as H0,
a distance between each of the retainer contact surfaces and a corresponding one of the housing contact surfaces (819) in a pressure-free state where the resilient members are placed in contact with the contact surface of the vehicle body component without being elastically deformed in the elastically urging direction is defined as H,
each of the initially-inserted surfaces is shaped to meet a relation of H<H0,
each of the slant surface portions is configured to change from a relation of H<H0 to a relation of H>H0, and
each of the flat surface portions is shaped to meet a relation of H>H0.

8. The sensor attachment as set forth in claim 7, wherein each of the initially-inserted portions extends s from a corresponding one of the resilient members in the attachment-inserting direction and is shaped to be smaller in inclination than a corresponding one of the slant surface portions.
